(19) United States
(12) Patent Application Publication
(10) Pub. No.: US 2023/0256841 A1
(43) Pub. Date: Aug. 17, 2023

(54) WALLBOX ELECTRIC VEHICLE SUPPLY EQUIPMENT (EVSE)

(71) Applicant: Webasto Charging Systems, Inc., Monrovia, CA (US)

(72) Inventor: Herman Joseph Steinbuchel, IV, Pasadena, CA (US)

(21) Appl. No.: 17/674,580

(22) Filed: Feb. 17, 2022

(51) Int. Cl. B60L 53/16

(52) U.S. Cl. CPC B60L 53/16; B60L 53/305

(57) ABSTRACT

Systems, devices, and methods including: an electric vehicle supply equipment (EVSE) housing; a faceplate attached to a first side of the EVSE housing; an electronics disposed within the EVSE housing; one or more EVSE wires connected to the electronics; and a potting compound disposed within the EVSE housing, where the potting compound encapsulates at least a portion of the electronics and the one or more EVSE wires.

### FIELD OF ENDEAVOR

The invention relates to electrical chargers, and more particularly to electric vehicle supply equipment (EVSE).

### BACKGROUND

An electrical connector is an apparatus used to transfer electricity from a power supply to a utility device, such as an electrical vehicle (EV). Electrical connectors generally have an internal connection that electrically connects one end of an electrical connector to the other end of the electrical connector. Some electrical connectors may be detachably plugged into a standard socket outlet. These plug electrical connectors may be damaged, lost, or stolen during operation.

### SUMMARY

A system embodiment may include: an electric vehicle supply equipment (EVSE) housing; a faceplate attached to a first side of the EVSE housing; an electronics disposed within the EVSE housing; one or more EVSE wires connected to the electronics; and a potting compound disposed within the EVSE housing, where the potting compound encapsulates at least a portion of the electronics and the one or more EVSE wires.

Additional system embodiments may include: a mounting surface, where the EVSE housing may be configured to fit within an opening of the mounting surface. In additional system embodiments, the faceplate may be configured to flush-mount to the mounting surface. In additional system embodiments, the mounting surface may be at least one of: a flat surface and a curved surface.

Additional system embodiments may include: a keypad disposed in the mounting surface, where the keypad may be in communication with the electronics to control charging. Additional system embodiments may include: a controller disposed in the mounting surface, where the controller may be in communication with the electronics and a user device to control charging.

Additional system embodiments may include: a cable coupler disposed within the EVSE housing, where at least a portion of the cable coupler may be encapsulated by the potting compound; a cable connected to the cable coupler; and a vehicle coupler connected to the cable, where the vehicle coupler may be configured to connect to an electric vehicle.

Additional system embodiments may include: a housing aperture disposed in the EVSE housing; and a cable clamp disposed proximate the housing aperture, where the cable clamp may be configured to secure a utility wiring to the EVSE housing. Additional system embodiments may include: one or more utility wires of the utility wiring; and one or more wire connectors configured to connect the one or more utility wires to the one or more EVSE wires to provide utility power from the utility wiring to the electronics.

An additional system embodiment may include: an electric vehicle supply equipment (EVSE) housing; an electronics disposed within the EVSE housing; one or more EVSE wires connected to the electronics; and a potting compound disposed within the EVSE housing, where the potting compound encapsulates at least a portion of the electronics and the one or more EVSE wires.

Additional system embodiments may include: an electrical wiring box, where the electrical wiring box may be configured to receive the EVSE housing via one or more fasteners. In additional system embodiments, the electrical wiring box comprises an electrical wiring box faceplate, where the electrical wiring box faceplate may be removable to attach the EVSE housing. In additional system embodiments, the electrical wiring box contains a utility wiring, where the utility wiring comprises one or more utility wires, and where the one or more utility wires are configured to connect to the one or more EVSE wires via one or more wire connectors ) to provide utility power from the utility wiring to the electronics.

Additional system embodiments may include: a cable coupler disposed within the EVSE housing, where at least a portion of the cable coupler may be encapsulated by the potting compound; a cable connected to the cable coupler; and a vehicle coupler connected to the cable, where the vehicle coupler may be configured to connect to an electric vehicle.

A method embodiment may include: removing an electrical wiring box faceplate from an electrical wiring box, where the electrical wiring box contains a utility wiring; securing one or more wires of the utility wiring to one or more wires of an EVSE via one or more wire connectors, where the one or more wires of the EVSE are connected to electronics of the EVSE, and where a portion of the one or more wires of the EVSE and the electronics of the EVSE are encapsulated in a potting compound; and securing a housing of the EVSE to the electrical wiring box via one or more fasteners.

Additional method embodiments may include: detaching the housing of the EVSE from the electrical wiring box faceplate via the one or more fasteners; detaching the one or more wires of the utility wiring from the one or more wires of the EVSE via the one or more wire connectors; and attaching the electrical wiring box faceplate to the electrical wiring box, where the electrical wiring box contains the utility wiring.

In additional method embodiments, a cable coupler may be disposed within the EVSE housing, and where at least a portion of the cable coupler may be encapsulated by the potting compound. In additional method embodiments, a cable may be connected to the cable coupler. In additional method embodiments, a vehicle coupler may be connected to the cable. In additional method embodiments, the vehicle coupler may be configured to connect to an electric vehicle.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a front perspective view of a wallbox electric vehicle supply equipment (EVSE), according to one embodiment;

FIG. 2 depicts a right side view of the wallbox EVSE of FIG. 1, according to one embodiment;

FIG. 3A depicts a rear perspective view of the wallbox EVSE of FIG. 1, according to one embodiment;

FIG. 3B depicts the wallbox EVSE of FIG. 3A with the rear cover removed, according to one embodiment;

FIG. 3C depicts the wallbox EVSE of FIG. 3B with a potting removed, according to one embodiment;

FIGS. 4A-4B depict a wallbox EVSE configured to mount flush to a flat surface of a wall, according to one embodiment;

FIGS. 5A-5B depict a wallbox EVSE configured to integrate into a bollard having a curved surface, according to one embodiment;

FIG. 6 depicts a dual post mount containing two wallbox EVSEs for access by two vehicles, according to one embodiment;

FIG. 7 depicts a quad post mount containing four wallbox EVSEs for access by four vehicles, according to one embodiment;

FIG. 8 depicts a dual post mount containing two wallbox EVSEs with retractable cable reels, according to one embodiment;

FIG. 9 depicts a dual post mount configured to rotatably receive a vehicle coupler, according to one embodiment;

FIG. 10 depicts a quad post mount configured to rotatably receive a vehicle coupler, according to one embodiment;

FIG. 11 depicts a wall mount outlet configured to receive a cable EVSE, according to one embodiment;

FIG. 12 depicts an exemplary system for a flush-mounted wallbox EVSE, according to one embodiment;

FIG. 13 depicts a flow chart of a method embodiment of installing a flush-mounted wallbox EVSE in a mounting surface, according to one embodiment;

FIG. 14 depicts a front perspective view of a wallbox-mounted EVSE and a wallbox, according to one embodiment;

FIG. 15A depicts a rear perspective view of the wallbox-mounted EVSE and the wallbox of FIG. 14, according to one embodiment;

FIG. 15B depicts the wallbox-mounted EVSE of FIG. 15A with a potting removed, according to one embodiment;

FIG. 16 depicts an exemplary system for a wallbox-mounted EVSE, according to one embodiment;

FIG. 17 depicts a flow chart of a method embodiment of installing a wallbox-mounted EVSE, according to one embodiment;

FIG. 18 depicts a flow chart of a method embodiment of removing a wallbox-mounted EVSE, according to one embodiment;

FIG. 19 depicts a flow chart of a method embodiment of forming a wallbox EVSE, according to one embodiment;

FIG. 20 illustrates an example top-level functional block diagram of a computing device embodiment, according to one embodiment;

FIG. 21 shows a high-level block diagram and process of a computing system for implementing an embodiment of the system and process, according to one embodiment;

FIG. 22 shows a block diagram and process of an exemplary system in which an embodiment may be implemented, according to one embodiment; and

FIG. 23 depicts a cloud-computing environment for implementing an embodiment of the system and process disclosed herein, according to one embodiment.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

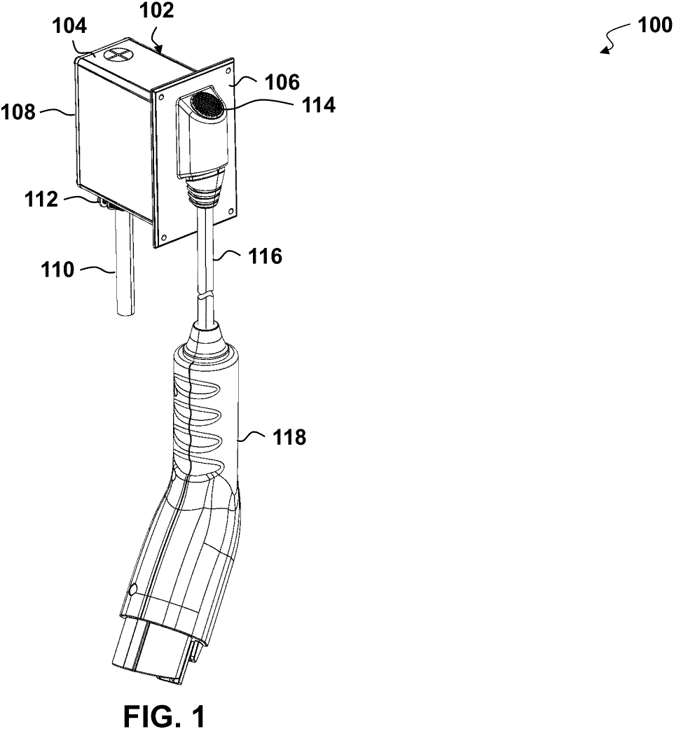

FIG. 1 depicts a front perspective view of a wallbox electric vehicle supply equipment (EVSE) 100, according to one embodiment. The wallbox EVSE 100 may include a body 102 having a housing 104 and faceplate 106. A cable 116 may extend through a portion of the faceplate 106. The cable 116 is shown as shortened for the sake of illustration, but may connect between electronics within the housing 104 and a vehicle coupler 118. The vehicle coupler 118 may plug in to an electric vehicle (EV) for charging of the EV. An indicator 114 may provide a status of the EVSE 100. In one embodiment, the indicator 114 may be a light that turns on, flashes, pulses, and/or changes color based on a status of the EVSE 100. In one embodiment, the indicator 114 may be a light that turns on when an EV connected to the EVSE 100 via the vehicle coupler 118 is being charged.

The body 102 may also include a rear cover 108. The faceplate 106 may be disposed on a first side of the body 102. The rear cover 108 may be disposed on a second side of the body 102, where the first side of the body 102 is opposite the second side of the body 102. A utility wiring 110 may enter into the housing 104. The utility wiring 110 may be secured relative to the housing 104 via a cable clamp 112.

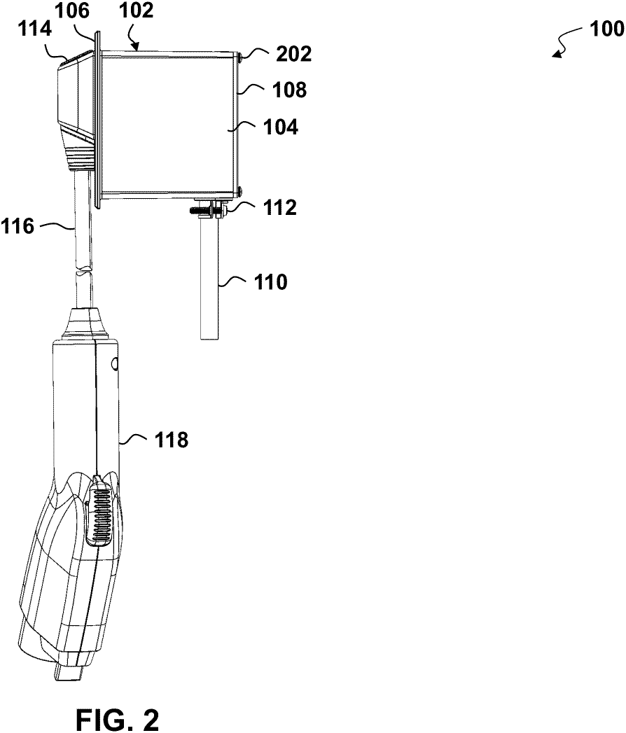

FIG. 2 depicts a right side view of the wallbox EVSE 100 of FIG. 1, according to one embodiment. The rear cover 108 may be detachably attached to the housing 104 via one or more fasteners 202. In one embodiment, the one or more fasteners 202 may be one or more screws, such as four screws attached at each corner of the rear cover 202.

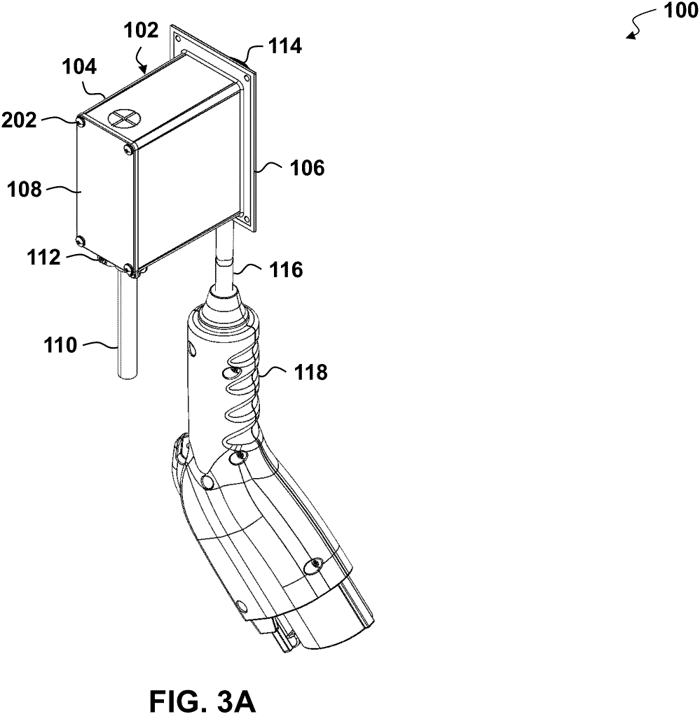

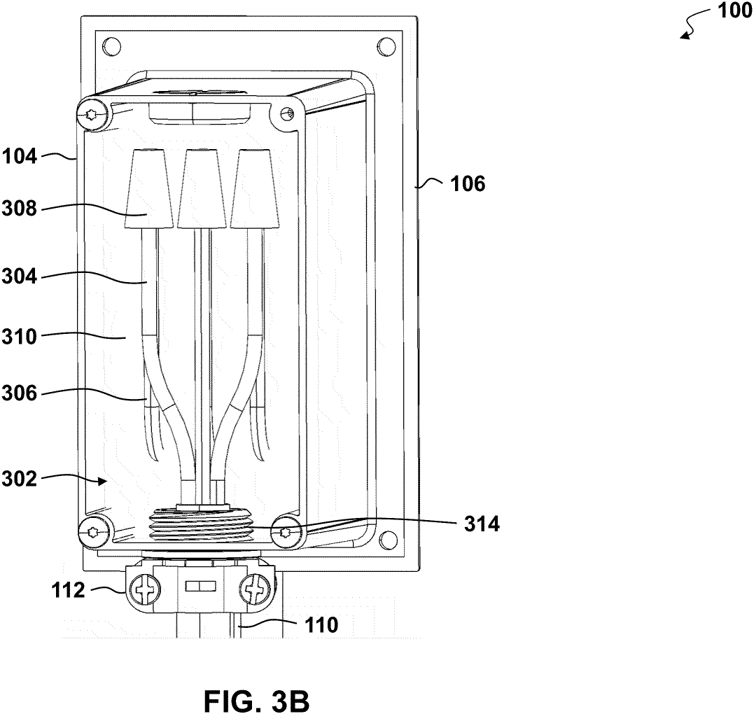

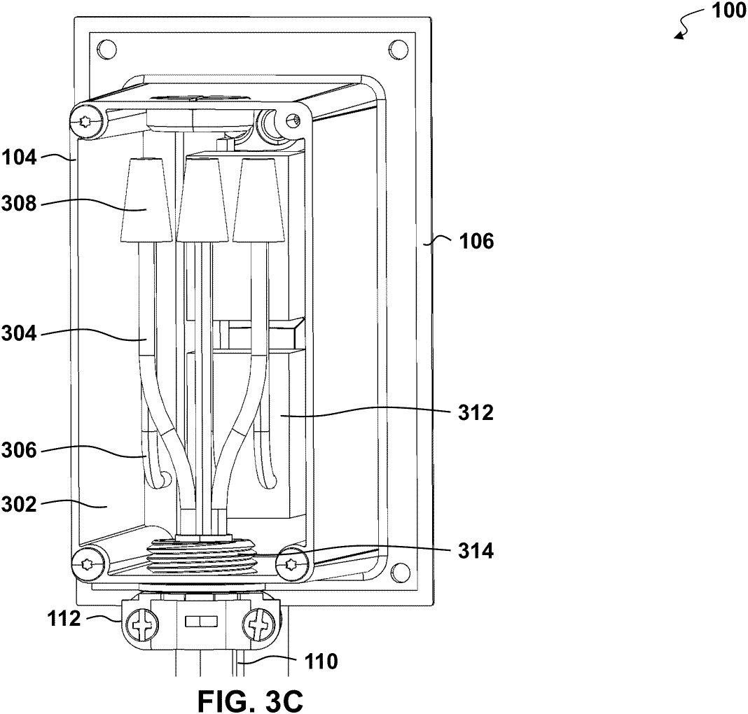

FIG. 3A depicts a rear perspective view of the wallbox EVSE 100 of FIG. 1, according to one embodiment. The rear cover 108 is secured to the housing 104 of the body 102 by one or more fasteners 202. The electronics of the EVSE and a connection to the utility wiring 110 is contained within the housing 104. Removing the rear cover 108 allows a user and/or installer to connect and/or disconnect the EVSE 100 from power supplied by the utility wiring 110.

FIG. 3B depicts the wallbox EVSE 100 of FIG. 3A with the rear cover removed, according to one embodiment. An interior 302 of the housing 104 of the EVSE may contain electronics, one or more EVSE wires 306, one or more utility wires 304 from the utility wiring 110, one or more wire connectors 308, and a potting compound 310. The potting compound 310 may encapsulate at least a portion of electronics (see FIG. 3C) and the one or more EVSE wires 306. The potting compound 310 may conceal the electronics from a user and/or installer so as to prevent damage to the electronics. The potting compound 310 may also protect the electronics from damage due to dust, dirt, water, or other elements. The potting compound 310 may provide vibration and/or shock resistance for the electronics of the EVSE 100. A user and/or installer removing the rear cover may only see the potting compound 310 and one or more EVSE wires 306 extending from the potting compound. Each of these one or more EVSE wires 306 may be connected to corresponding one or more utility wires 304 via one or more wire connectors 308. In one embodiment, the hot wires, neutral wires, and ground wires may be connected together to provide an electrical connection to the EVSE 100 to allow for charging of an EV.

The housing 104 may include one or more housing apertures 314 to receive the utility wiring 110. The utility wiring 110 may be secured proximate the housing 104 via a cable clamp 112. The cable clamp 112 may prevent the utility wiring 110 from being removed from the EVSE 100 so as to prevent a disconnection between the EVSE wires 306 and the utility wires 304.

FIG. 3C depicts the wallbox EVSE 100 of FIG. 3B with a potting compound removed, according to one embodiment. The potting compound may encapsulate at least a portion of the EVSE wires 306 and at least a portion of the electronics 312. In some embodiments, the electronics 312 may be completely encapsulated by the potting compound. The electronics 312 may include one or more processors. The electronics 312 may be used to start and stop charging, monitor charging, control the indicator (114, FIG. 1), track charging amounts, and the like. The potting compound may prevent damage to the electronics 312. The potting compound may provide heat dissipation to the electronics 312.

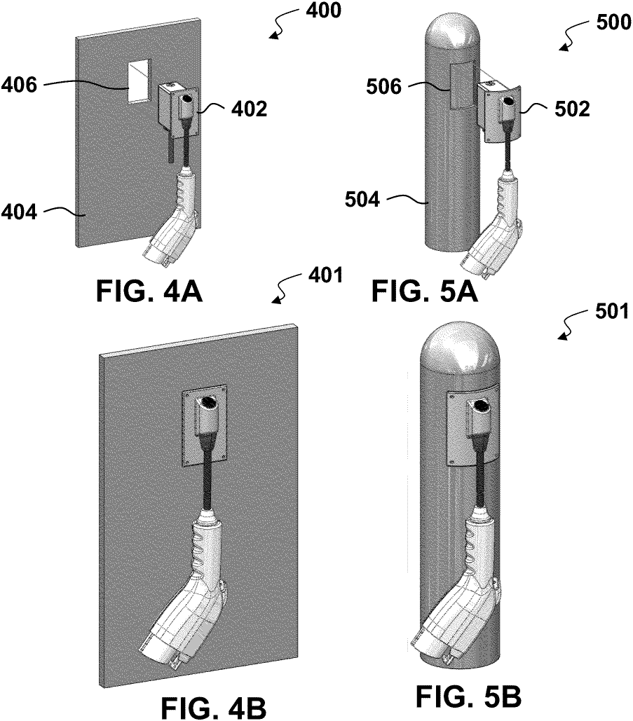

FIGS. 4A-4B depict a wallbox EVSE configured to mount flush to a flat surface of a wall, according to one embodiment. The EVSE 402 may be inserted into an opening 406 in a flat mounting surface 404 such as a wall. The EVSE 402 may be connected to utility wiring through the opening 406 in a first position 400 and then a portion of the EVSE 402 may be placed into the opening 406 such that a faceplate of the EVSE 402 is flush against the flat mounting surface 404 in a second installed position 401.

FIGS. 5A-5B depict a wallbox EVSE configured to integrate into a bollard having a curved surface 500, according to one embodiment. The EVSE 502 may be inserted into an opening 506 in a curved mounting surface 504 such as a post or bollard. The EVSE 502 may be connected to utility wiring through the opening 506 in a first position 500 and then a portion of the EVSE 502 may be placed into the opening 506 such that a curved faceplate of the EVSE 502 is flush against the curved mounting surface 504 in a second installed position 501.

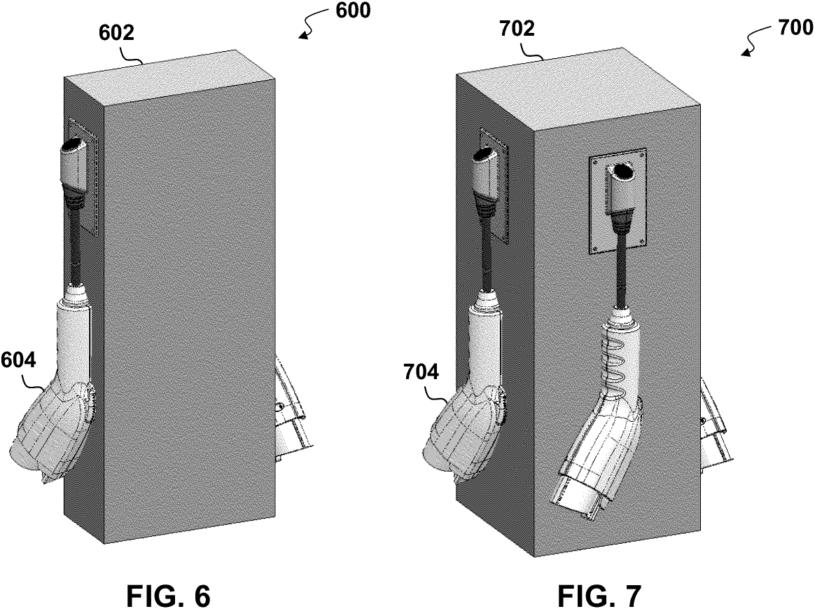

FIG. 6 depicts a dual post mount containing two wallbox EVSEs for access by two vehicles 600, according to one embodiment. A mounting surface 602 may have two EVSEs 604 such that two EVs could each use respective EVSEs 604 for charging.

FIG. 7 depicts a quad post mount containing four wallbox EVSEs for access by four vehicles 700, according to one embodiment. A mounting surface 702 may have four EVSEs 704 such that four EVs could each use respective EVSEs 704 for charging. Additional EVSE configurations on varying mounting surfaces are possible and contemplated.

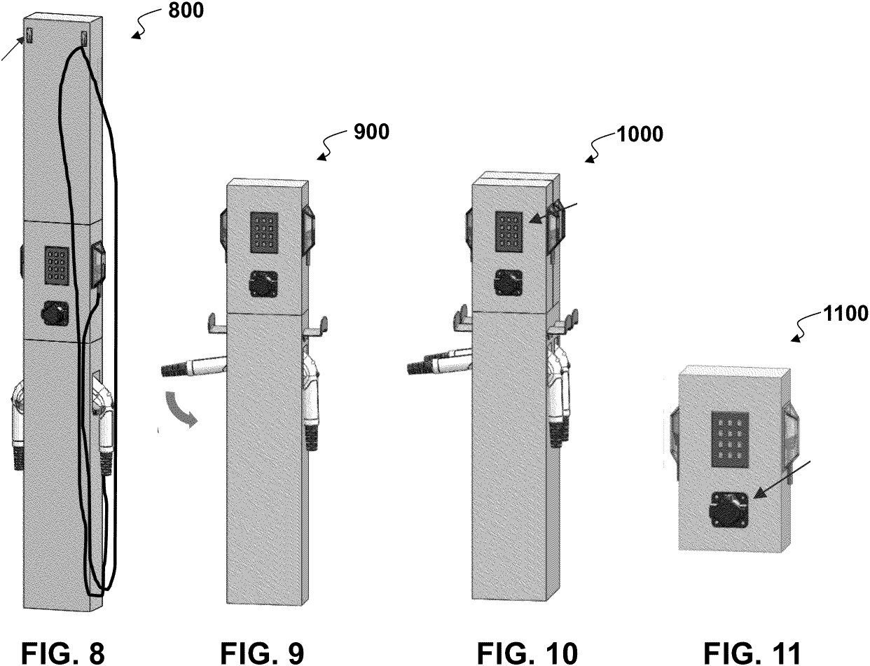

FIG. 8 depicts a dual post mount containing two wallbox EVSEs with retractable cable reels 800, according to one embodiment. The dual post mount 800 may include a retractable cable reel to keep cables for each EVSE from becoming tangled or being on the ground in embodiments where a longer cable length is desired.

FIG. 9 depicts a dual post mount configured to rotatably receive a vehicle coupler 900, according to one embodiment. In one embodiment, the vehicle coupler may be inserted in a first position where the vehicle coupler is substantially horizontal relative to the ground. Once an end of the vehicle coupler is received in a dock, the vehicle coupler may swing down or rotate to a second position where the vehicle coupler is substantially vertical relative to the ground. To remove the vehicle coupler from the dock, the vehicle coupler may be rotated from the second position to the first position and then lifted out of the dock. This docking system disclosed herein may prevent inadvertent removal of the vehicle couplers such as via bumping the vehicle coupler while secured in the dock.

FIG. 10 depicts a quad post mount configured to rotatably receive a vehicle coupler 1000, according to one embodiment. The quad post mount may include an access control keypad in some embodiments. The access control keypad may require entry of a code to allow for charging an EV via the one or more EVSEs. In some embodiments, the keypad may be in communication with an application such as a smartphone application that provides a code to a user to allow for charging of an EV via the one or more EVSEs.

FIG. 11 depicts a wall mount outlet configured to receive a cable EVSE 1100, according to one embodiment. In some embodiments, the keypad or other input may allow for charging via an outlet. In these embodiments, the user may supply their own EVSE cable to plug into an outlet where power to the outlet is controlled via the keypad or other input.

The outlet, keypad, post, and wall mount may all be configurable options. In some embodiments, there may be wireless communication between the user and the EVSE module or between adjacent modules. In some embodiments, charge authorization may be through wireless communication with the EVSE module and/or RFID. In some embodiments, the EVSE module may be mounted on a post or to a wall either with or without the cable management column.

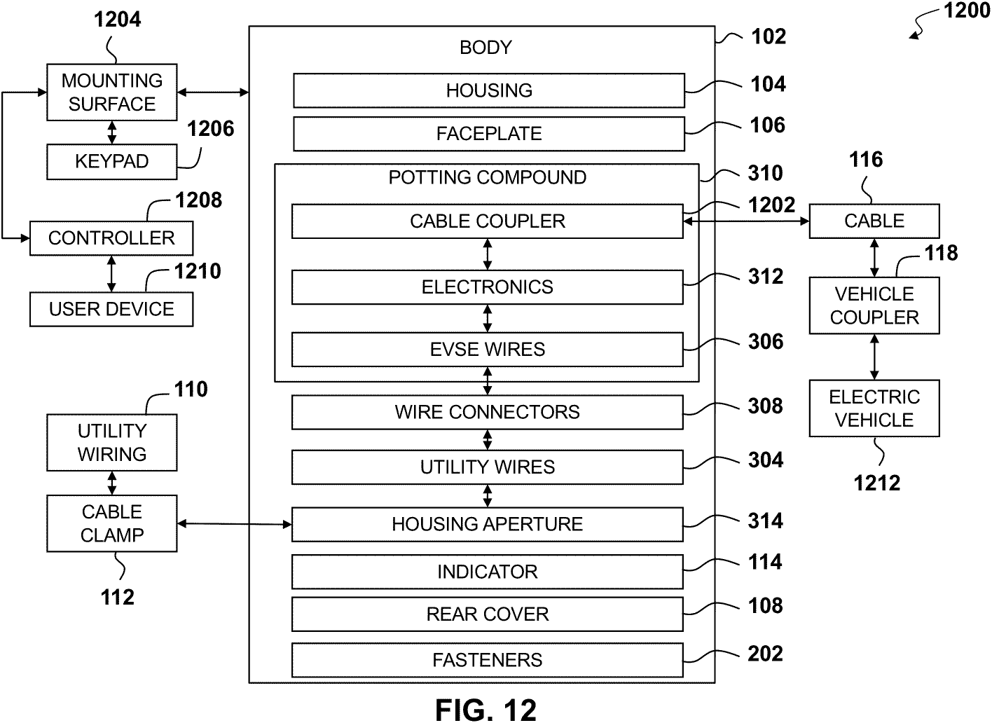

FIG. 12 depicts an exemplary system for a flush-mounted wallbox EVSE 1200, according to one embodiment. The EVSE 1200 may include a body 102 having a housing 104, faceplate 106, housing aperture 314, indicator 114, rear cover 108, and/or fasteners 202. A potting compound 310 may be disposed within the housing 104 and encapsulate one or more of: a cable coupler 1202, an electronics 312, and at least a portion of one or more EVSE wires 306. The cable coupler 1202 may connect the cable 116 with the electronics 312 of the EVSE 1200. The cable 116 may connect to a vehicle coupler 118 for charging an electric vehicle (EV) 1212. A utility wiring 110 may be secured to the housing 104 via a cable clamp 112. The utility wiring 110 may enter the housing 104 via a housing aperture 314. The one or more utility wires 304 of the utility wiring 110 may be connected to the one or more EVSE wires 306 of the EVSE 1200 via one or more wire connectors 308. The EVSE wires may then supply power to the electronics 312 from the utility wiring 110. The EVSE 1200 may be mounted in a mounting surface 1204. In some embodiments, the mounting surface 1204 may include a keypad 1206. In other embodiments, the mounting surface 1204 may include a controller 1208 in communication with a user device 1210.

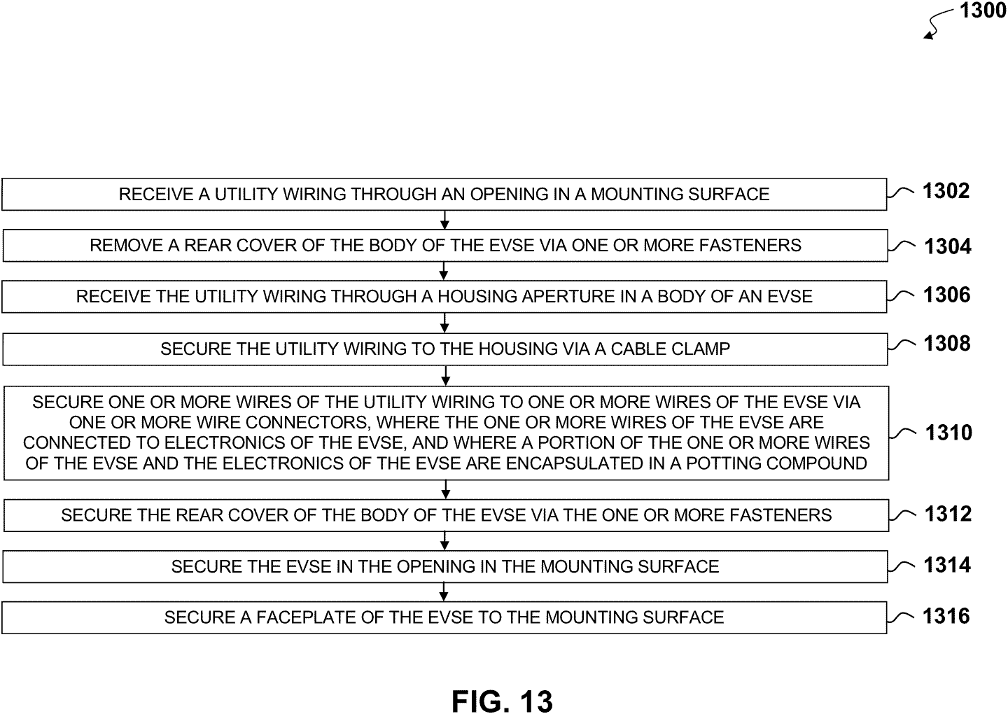

FIG. 13 depicts a flow chart of a method embodiment 1300 of installing a flush-mounted wallbox EVSE in a mounting surface, according to one embodiment. The method 1300 may include receiving a utility wiring through an opening in a mounting surface (step 1302). The method 1300 may then include removing a rear cover of the body of the EVSE via one or more fasteners (step 1304). The method 1300 may then include receiving the utility wiring through a housing aperture in a body of an EVSE (step 1306). The method 1300 may then include securing the utility wiring to the housing via a cable clamp (step 1308). The method 1300 may then include securing one or more wires of the utility wiring to one or more wires of the EVSE via one or more wire connectors, where the one or more wires of the EVSE are connected to electronics of the EVSE, and where a portion of the one or more wires of the EVSE and the electronics of the EVSE are encapsulated in a potting compound (step 1310). The method 1300 may then include securing the rear cover of the body of the EVSE via the one or more fasteners (step 1312). The method 1300 may then include securing the EVSE in the opening in the mounting surface (step 1314). The method 1300 may then include securing a faceplate of the EVSE to the mounting surface (step 1316). In some embodiments, steps 1314, 1316 the faceplate may be separate from the enclosure. In other embodiments, steps 1314, 1316 the faceplate may be a part of the enclosure.

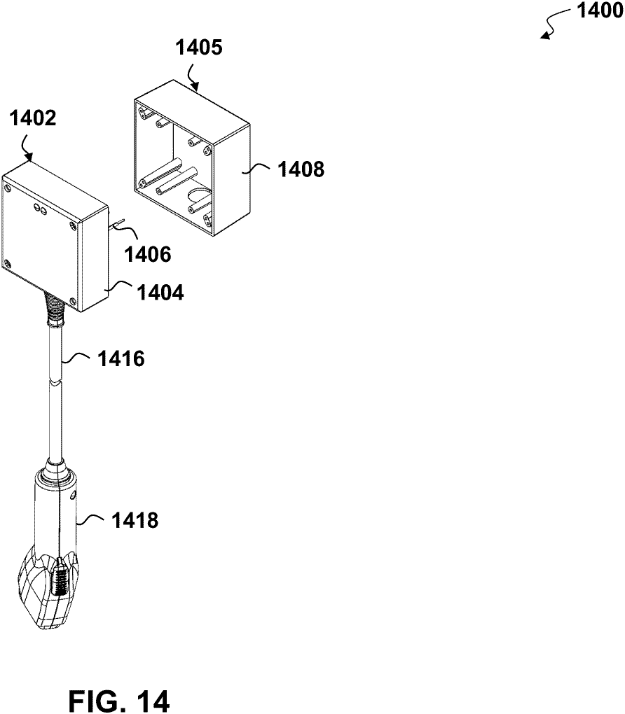

FIG. 14 depicts a front perspective view of a wallbox-mounted EVSE and a wallbox 1400, according to one embodiment. The wallbox-mounted EVSE 1402 includes a body 1402, a housing 1404, one or more EVSE wires 1406, a cable 1416, and a vehicle coupler 1618. The electrical wiring box 1405 includes a wiring box body 1408. A utility wiring may be disposed within the electrical wiring box 1405. The electrical wiring box 1405 may be a standard fixture, such as an electrical box disposed in a parking structure. The disclosed wallbox-mounted EVSE 1402 may be attached to this electrical box when an EVSE is desired at a location for existing utility wiring. The disclosed wallbox-mounted EVSE 1402 may then be detached from this electrical wiring box 1405 and relocated when an EVSE is no longer needed in a desired location. In some embodiments, the wallbox 1400 may be used for rough-in wiring of a structure and the final installation of the EVSE may happen later. The wallbox 1402 is an EVSE mounted to the wall. The electrical wiring box 1405 may be a commercially available electrical wiring box. The EVSE wallbox 1402 itself mounts directly to the electrical wiring box 1405. The wallbox 1402 enclosure 1404 is the enclosure of the EVSE itself.

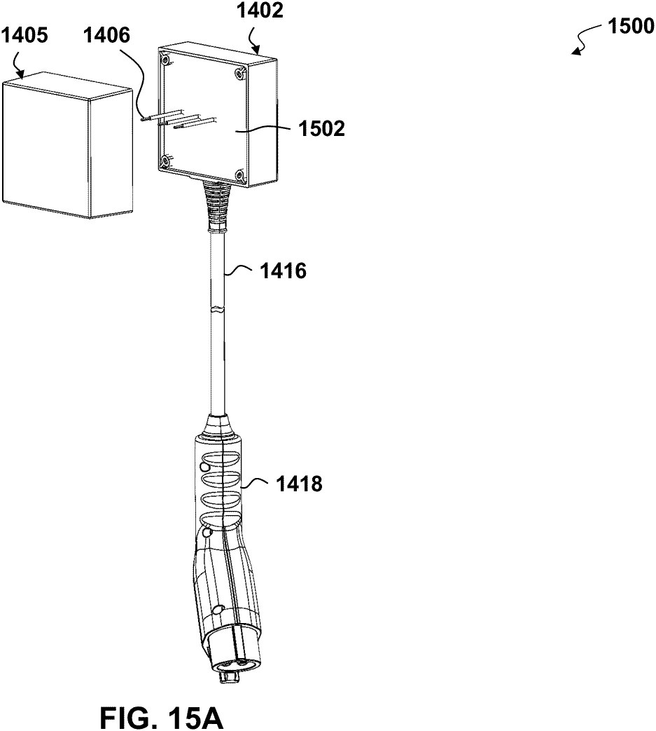

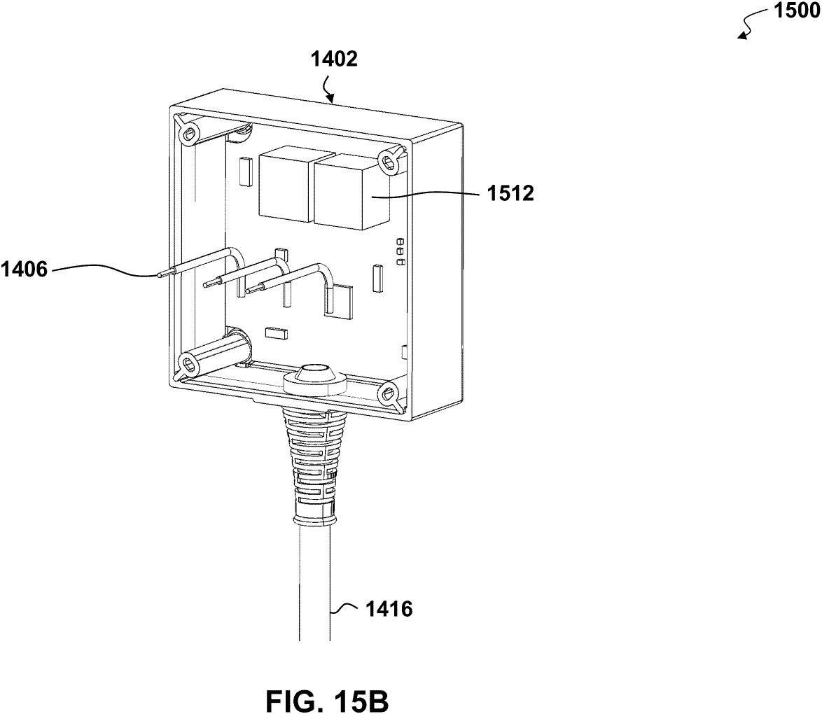

FIG. 15A depicts a rear perspective view of the wallbox-mounted EVSE and the wallbox of FIG. 14 1500, according to one embodiment. The wallbox-mounted EVSE 1402 may include a potting compound 1502 within a housing of the wallbox-mounted EVSE 1402. One or more EVSE wires 1406 may be partially encapsulated by the potting compound 1502 such that only the one or more EVSE wires 1406 are visible to a user or installer and any electronics are concealed within the potting compound 1502. The potting compound 1502 prevents damage to the electronics of the wallbox-mounted EVSE 1402. The EVSE wires 1406 may be connected to utility wiring in the electrical wiring box 1405.

FIG. 15B depicts the wallbox-mounted EVSE of FIG. 15A with a potting removed 1500, according to one embodiment. The electronics 1512 are contained within the housing of the wallbox-mounted EVSE 1402. The one or more EVSE wires 1406 are connected to the electronics 1512. The one or more EVSE wires 1406 may be connected to one or more corresponding utility wires to provide power to the EVSE. In one embodiment, the one or more EVSE wires 1406 may contain a hot, neutral, and ground wire for connecting to hot, neutral, and ground utility wires.

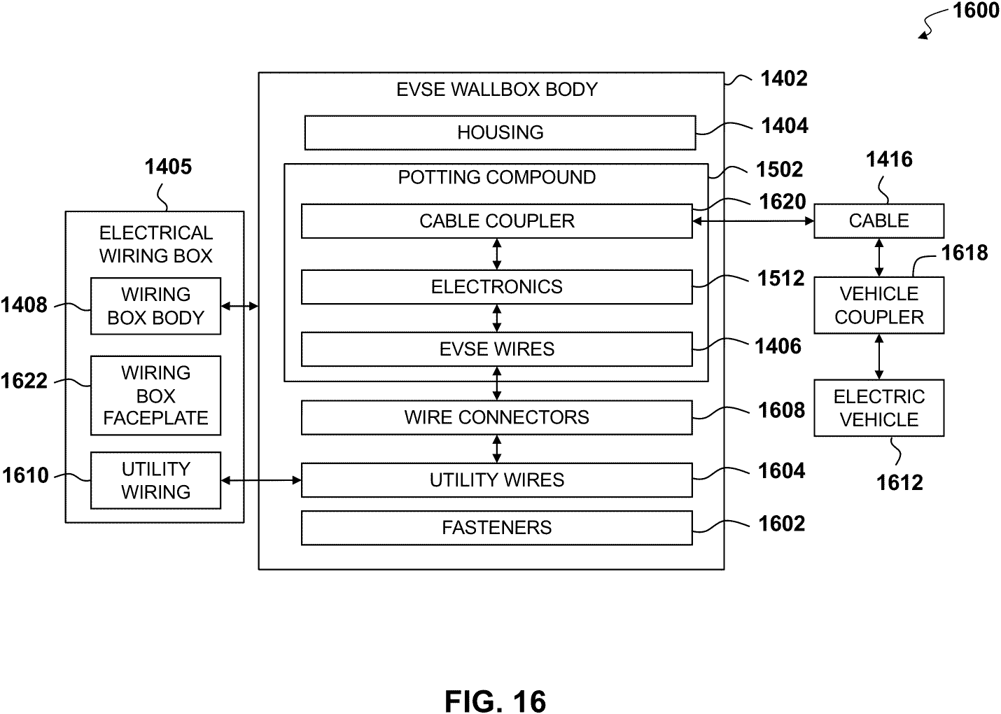

FIG. 16 depicts an exemplary system for a wallbox-mounted EVSE 1600, according to one embodiment. The EVSE 1600 may include an EVSE wallbox body 1402 having a housing 1404, a cable coupler 1620, an electronics 1512, one or more EVSE wires 1406, and a potting compound 1502. The potting compound 1502 may encapsulate at least a portion of the cable coupler 1620, electronics 1512, and one or more EVSE wires 1406. The cable coupler 1620 may connect a cable 1416 to the electronics 1512. The cable 1416 may be connected to a vehicle coupler 1618 for charging an electric vehicle (EV) 1612. An electrical wiring box 1405 may include a wiring box body 1408, a wiring box faceplate 1622, and a utility wiring 1610. The utility wiring 1610 may be disposed within the electrical wiring box 1406. The wiring box faceplate 1622 may be used to conceal the utility wiring 1610 within the electrical wiring box 1405 when the electrical wiring box 1405 is not in use. In some embodiments, the electrical wiring box 1405 does not contain any electronics and is a junction box. The EVSE wallbox body 1402 that mounts to the electrical wiring box 1405 is the enclosure of the EVSE.

When the EVSE 1600 is ready to be installed, the wallbox faceplate 1622 may be removed. The one or more utility wires 1604 of the utility wiring 1610 within the wallbox 1406 may then be connected to the EVSE wires 1406 via one or more wire connectors 1608. The connected wiring may then be placed within the wallbox 1406 and the EVSE body 1402 may be attached to the wallbox 1406 via one or more fasteners 1602. The wallbox faceplate 1622 may be replaced with the EVSE 1600 when the EVSE 1600 is connected to the wallbox 1406.

When the EVSE 1600 is ready to be removed from the wallbox 1406, the EVSE body 1402 may be detached from the wallbox body 1408 via the one or more fasteners 1602. The wire connectors 1608 connecting the one or more EVSE wires 1406 and the one or more utility wires 1604 may then be removed and the EVSE wires 1406 may be detached from the one or more utility wires 1604. The one or more utility wires 1604 may then be placed within the wallbox body 1408 and the wallbox faceplate 1622 may be reattached to the wallbox 1406. The EVSE 1600 may then be transported and installed in any new wallbox as desired by a user and/or installer.

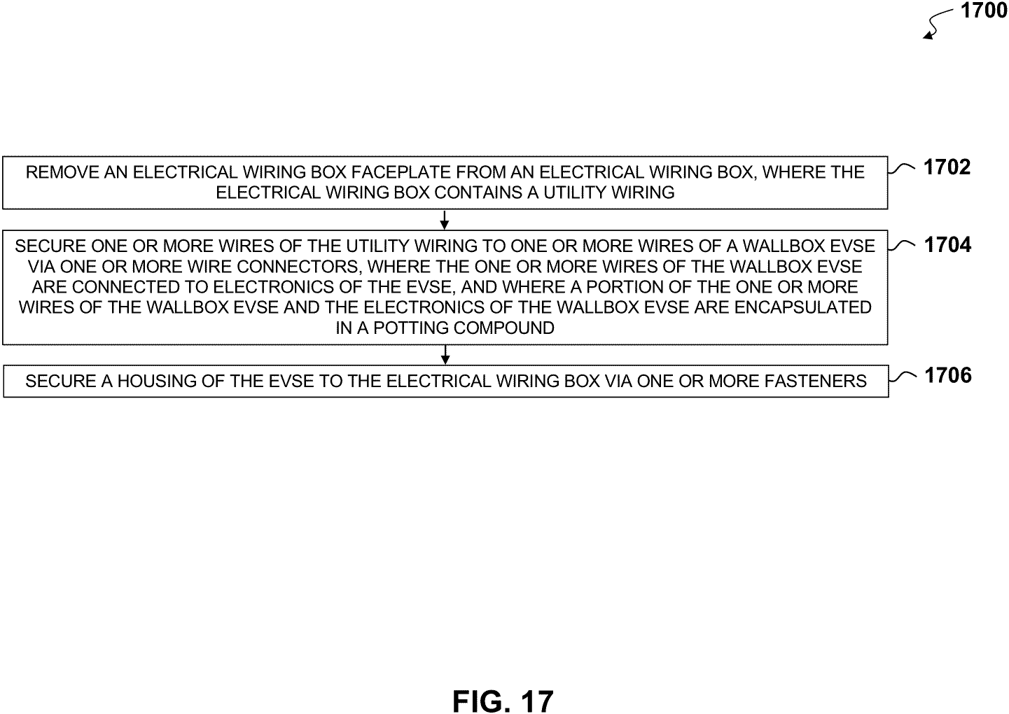

FIG. 17 depicts a flow chart of a method embodiment 1700 of installing a wallbox-mounted EVSE, according to one embodiment. The method 1700 may include removing an electrical wiring box faceplate from an electrical wiring box, where the electrical wiring box contains a utility wiring (step 1702). The method 1700 may then include securing one or more wires of the utility wiring to one or more wires of a Wallbox EVSE via one or more wire connectors, where the one or more wires of the Wallbox EVSE are connected to electronics of the Wallbox EVSE, and where a portion of the one or more wires of the Wallbox EVSE and the electronics of the Wallbox EVSE are encapsulated in a potting compound (step 1704). The method 1700 may then include securing a housing of the Wallbox EVSE to the electrical wiring box via one or more fasteners (step 1706).

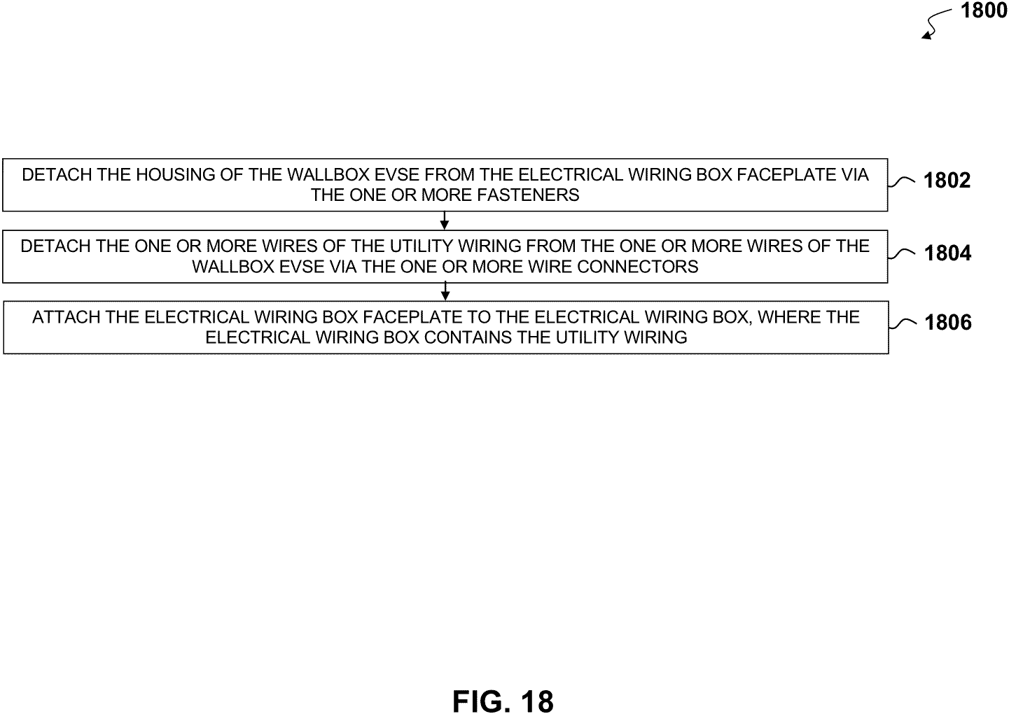

FIG. 18 depicts a flow chart of a method embodiment 1800 of removing a wallbox-mounted EVSE, according to one embodiment. The method 1800 may include detaching the housing of the Wallbox EVSE from the electrical wiring box faceplate via the one or more fasteners (step 1802). The method 1800 may then include detaching the one or more wires of the utility wiring from the one or more wires of the Wallbox EVSE via the one or more wire connectors (step 1804). The method 1800 may then include attaching the electrical wiring box faceplate to the electrical wiring box, where the electrical wiring box contains the utility wiring (step 1806).

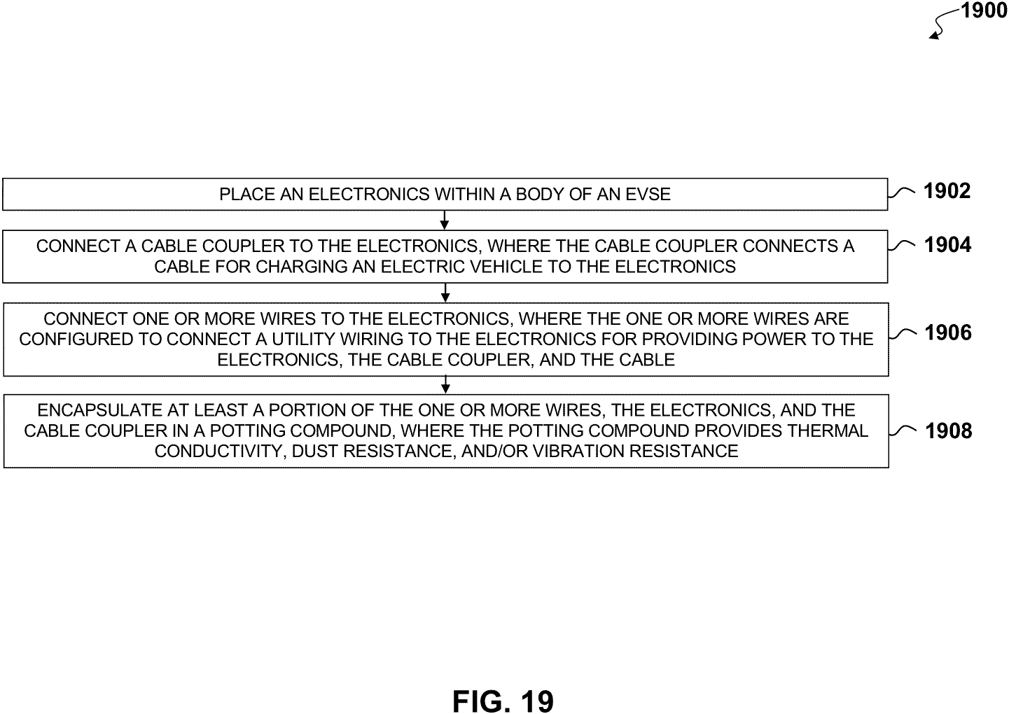

FIG. 19 depicts a flow chart of a method embodiment 1900 of forming a wallbox EVSE, according to one embodiment. The method 1900 may include placing an electronics within a body of an EVSE (step 1902). The method 1900 may then include connecting a cable coupler to the electronics, where the cable coupler connects a cable for charging an electric vehicle to the electronics (step 1904). The method 1900 may then include connecting one or more wires to the electronics, where the one or more wires are configured to connect a utility wiring to the electronics for providing power to the electronics, the cable coupler, and the cable (step 1906). The method 1900 may then include encapsulating at least a portion of the one or more wires, the electronics, and the cable coupler in a potting compound, where the potting compound provides thermal conductivity, dust resistance, and/or vibration resistance (step 1908). In some embodiment, the EVSE may be built without the potting compound.

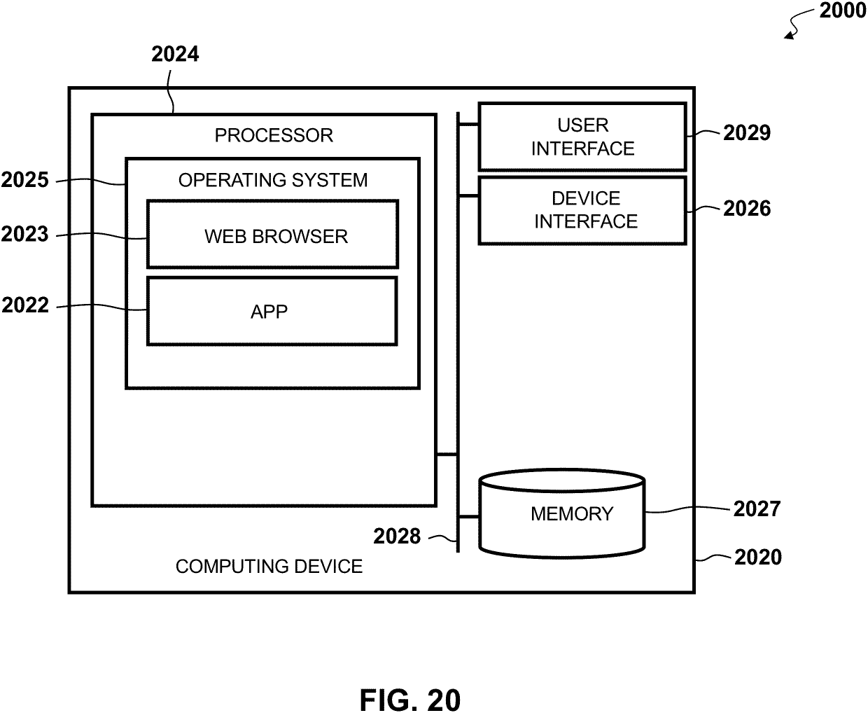

FIG. 20 illustrates an example of a top-level functional block diagram of a computing device embodiment 2000. The example operating environment is shown as a computing device 2020 comprising a processor 2024, such as a central processing unit (CPU), addressable memory 2027, an external device interface 2026, e.g., an optional universal serial bus port and related processing, and/or an Ethernet port and related processing, and an optional user interface 2029, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 2028. In some embodiments, via an operating system 2025 such as one supporting a web browser 2023 and applications 2022, the processor 2024 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller’s search for finding buyers for their property. The figures described below provide more details about the implementation of the devices and how they may interact with each other using the disclosed technology.

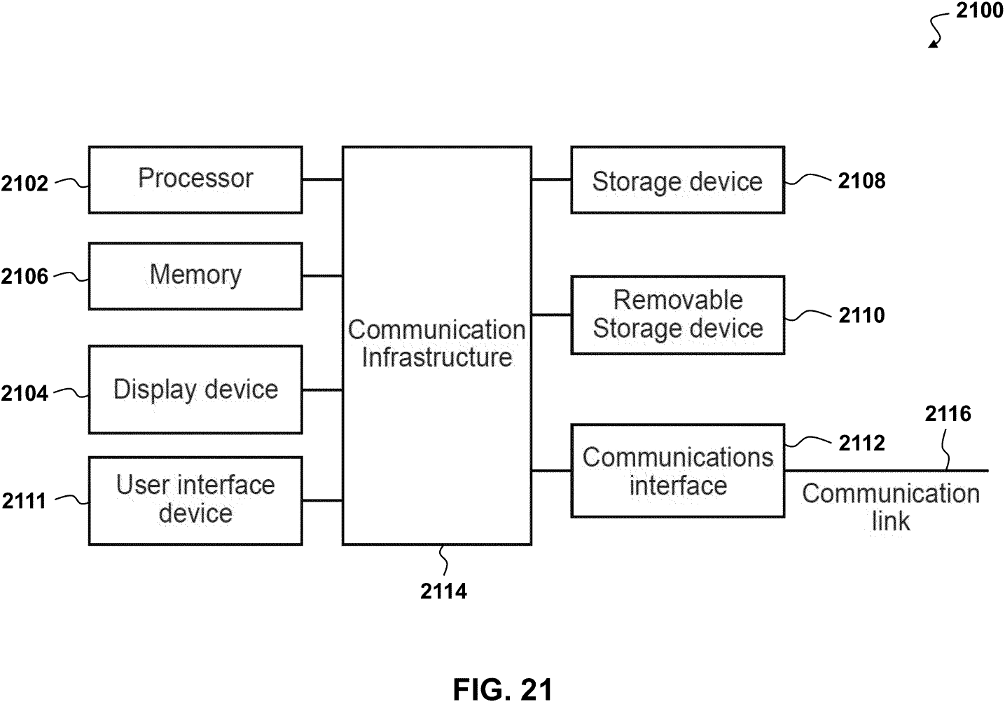

FIG. 21 is a high-level block diagram 2100 showing a computing system comprising a computer system useful for implementing an embodiment of the system and process, disclosed herein. Embodiments of the system may be implemented in different computing environments. The computer system includes one or more processors 2102, and can further include an electronic display device 2104 (e.g., for displaying graphics, text, and other data), a main memory 2106 (e.g., random access memory (RAM)), storage device 2108, a removable storage device 2110 (e.g., removable storage drive, a removable memory module, a magnetic tape drive, an optical disk drive, a computer readable medium having stored therein computer software and/or data), user interface device 2111 (e.g., keyboard, touch screen, keypad, pointing device), and a communication interface 2112 (e.g., modem, a network interface (such as an Ethernet card), a communications port, or a PCMCIA slot and card). The communication interface 2112 allows software and data to be transferred between the computer system and external devices. The system further includes a communications infrastructure 2114 (e.g., a communications bus, cross-over bar, or network) to which the aforementioned devices/modules are connected as shown.

Information transferred via communications interface 2114 may be in the form of signals such as electronic, electromagnetic, optical, or other signals capable of being received by communications interface 2114, via a communication link 2116 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 2112. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

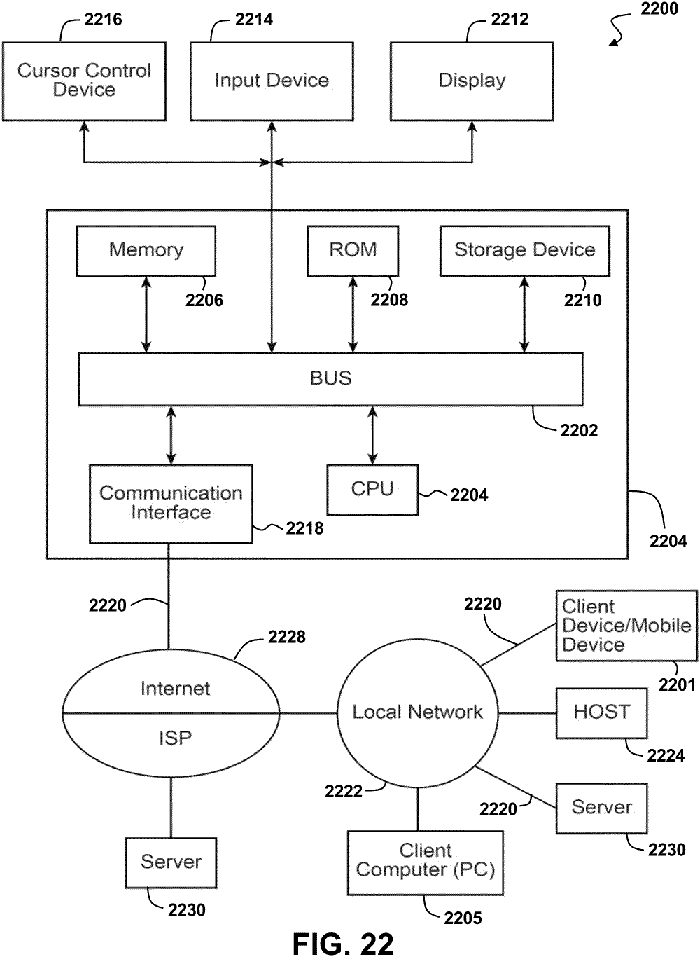

FIG. 22 shows a block diagram of an example system 2200 in which an embodiment may be implemented. The system 2200 includes one or more client devices 2201 such as consumer electronics devices, connected to one or more server computing systems 2230. A server 2230 includes a bus 2202 or other communication mechanism for communicating information, and a processor (CPU) 2204 coupled with the bus 2202 for processing information. The server 2230 also includes a main memory 2206, such as a random access memory (RAM) or other dynamic storage device, coupled to the bus 2202 for storing information and instructions to be executed by the processor 2204. The main memory 2206 also may be used for storing temporary variables or other intermediate information during execution or instructions to be executed by the processor 2204. The server computer system 2230 further includes a read only memory (ROM) 2208 or other static storage device coupled to the bus 2202 for storing static information and instructions for the processor 2204. A storage device 2210, such as a magnetic disk or optical disk, is provided and coupled to the bus 2202 for storing information and instructions. The bus 2202 may contain, for example, thirty-two address lines for addressing video memory or main memory 2206. The bus 2202 can also include, for example, a 32-bit data bus for transferring data between and among the components, such as the CPU 2204, the main memory 2206, video memory and the storage 2210. Alternatively, multiplex data/address lines may be used instead of separate data and address lines.

The server 2230 may be coupled via the bus 2202 to a display 2212 for displaying information to a computer user. An input device 2214, including alphanumeric and other keys, is coupled to the bus 2202 for communicating information and command selections to the processor 2204. Another type or user input device comprises cursor control 2216, such as a mouse, a trackball, or cursor direction keys for communicating direction information and command selections to the processor 2204 and for controlling cursor movement on the display 2212.

According to one embodiment, the functions are performed by the processor 2204 executing one or more sequences of one or more instructions contained in the main memory 2206. Such instructions may be read into the main memory 2206 from another computer-readable medium, such as the storage device 2210. Execution of the sequences of instructions contained in the main memory 2206 causes the processor 2204 to perform the process steps described herein. One or more processors in a multi-processing arrangement may also be employed to execute the sequences of instructions contained in the main memory 2206. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 2204 for execution. Such a medium may take many forms, including but not limited to, non-volatile media, volatile media, and transmission media. Non-volatile media includes, for example, optical or magnetic disks, such as the storage device 2210. Volatile media includes dynamic memory, such as the main memory 2206. Transmission media includes coaxial cables, copper wire and fiber optics, including the wires that comprise the bus 2202. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 2204 for execution. For example, the instructions may initially be carried on a magnetic disk of a remote computer. The remote computer can load the instructions into its dynamic memory and send the instructions over a telephone line using a modem. A modem local to the server 2230 can receive the data on the telephone line and use an infrared transmitter to convert the data to an infrared signal. An infrared detector coupled to the bus 2202 can receive the data carried in the infrared signal and place the data on the bus 2202. The bus 2202 carries the data to the main memory 2206, from which the processor 2204 retrieves and executes the instructions. The instructions received from the main memory 2206 may optionally be stored on the storage device 2210 either before or after execution by the processor 2204.

The server 2230 also includes a communication interface 2218 coupled to the bus 2202. The communication interface 2218 provides a two-way data communication coupling to a network link 2220 that is connected to the world wide packet data communication network now commonly referred to as the Internet 2228. The Internet 2228 uses electrical, electromagnetic or optical signals that carry digital data streams. The signals through the various networks and the signals on the network link 2220 and through the communication interface 2218, which carry the digital data to and from the server 2230, are exemplary forms or carrier waves transporting the information.

In another embodiment of the server 2230, interface 2218 is connected to a network 2222 via a communication link 2220. For example, the communication interface 2218 may be an integrated services digital network (ISDN) card or a modem to provide a data communication connection to a corresponding type of telephone line, which can comprise part of the network link 2220. As another example, the communication interface 2218 may be a local area network (LAN) card to provide a data communication connection to a compatible LAN. Wireless links may also be implemented. In any such implementation, the communication interface 2218 sends and receives electrical electromagnetic or optical signals that carry digital data streams representing various types of information.

The network link 2220 typically provides data communication through one or more networks to other data devices. For example, the network link 2220 may provide a connection through the local network 2222 to a host computer 2224 or to data equipment operated by an Internet Service Provider (ISP). The ISP in turn provides data communication services through the Internet 2228. The local network 2222 and the Internet 2228 both use electrical, electromagnetic or optical signals that carry digital data streams. The signals through the various networks and the signals on the network link 2220 and through the communication interface 2218, which carry the digital data to and from the server 2230, are exemplary forms or carrier waves transporting the information.

The server 2230 can send/receive messages and data, including e-mail, program code, through the network, the network link 2220 and the communication interface 2218. Further, the communication interface 2218 can comprise a USB/Tuner and the network link 2220 may be an antenna or cable for connecting the server 2230 to a cable provider, satellite provider or other terrestrial transmission system for receiving messages, data and program code from another source.

The example versions of the embodiments described herein may be implemented as logical operations in a distributed processing system such as the system 2200 including the servers 2230. The logical operations of the embodiments may be implemented as a sequence of steps executing in the server 2230, and as interconnected machine modules within the system 2200. The implementation is a matter of choice and can depend on performance of the system 2200 implementing the embodiments. As such, the logical operations constituting said example versions of the embodiments are referred to for e.g., as operations, steps or modules.

Similar to a server 2230 described above, a client device 2201 can include a processor, memory, storage device, display, input device and communication interface (e.g., e-mail interface) for connecting the client device to the Internet 2228, the ISP, or LAN 2222, for communication with the servers 2230.

The system 2200 can further include computers (e.g., personal computers, computing nodes) 2205 operating in the same manner as client devices 2201, where a user can utilize one or more computers 2205 to manage data in the server 2230.

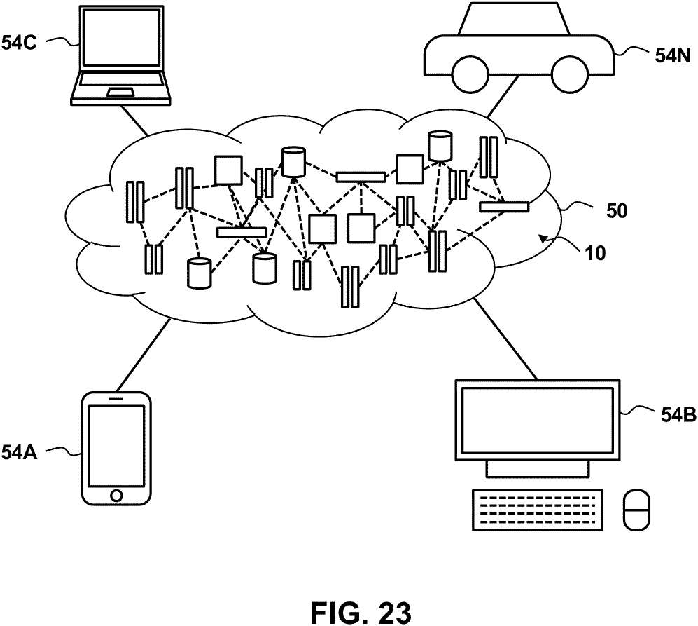

Referring now to FIG. 23, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or unmanned aerial system (UAS) 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 23 are intended to be illustrative only and that computing nodes 10 and cloud computing environment 50 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

What is claimed is:

1. A system, comprising:
an electric vehicle supply equipment (EVSE) housing;
a faceplate attached to a first side of the EVSE housing;
an electronics disposed within the EVSE housing;
one or more EVSE wires connected to the electronics; and
a potting compound disposed within the EVSE housing, wherein the potting compound encapsulates at least a portion of the electronics and the one or more EVSE wires.

2. The system of claim 1, further comprising:
a mounting surface, wherein the EVSE housing is configured to fit within an opening of the mounting surface.

3. The system of claim 2, wherein the faceplate is configured to flush-mount to the mounting surface.

4. The system of claim 2, wherein the mounting surface is at least one of: a flat surface and a curved surface.

5. The system of claim 2, further comprising:
a keypad disposed in the mounting surface, wherein the keypad is in communication with the electronics to control charging.

6. The system of claim 2, further comprising:
a controller disposed in the mounting surface, wherein the controller is in communication with the electronics and a user device to control charging.

7. The system of claim 1, further comprising:
a cable coupler disposed within the EVSE housing, wherein at least a portion of the cable coupler is encapsulated by the potting compound;
a cable connected to the cable coupler; and
a vehicle coupler connected to the cable, wherein the vehicle coupler is configured to connect to an electric vehicle.

8. The system of claim 1, further comprising:
a housing aperture disposed in the EVSE housing; and
a cable clamp disposed proximate the housing aperture, wherein the cable clamp is configured to secure a utility wiring to the EVSE housing.

9. The system of claim 8, further comprising:
one or more utility wires of the utility wiring; and
one or more wire connectors configured to connect the one or more utility wires to the one or more EVSE wires to provide utility power from the utility wiring to the electronics.

10. A system, comprising:
an electric vehicle supply equipment (EVSE) housing;
an electronics disposed within the EVSE housing;
one or more EVSE wires connected to the electronics; and
a potting compound disposed within the EVSE housing, wherein the potting compound encapsulates at least a portion of the electronics and the one or more EVSE wires.

11. The system of claim 10, further comprising:
an electrical wiring box, wherein the electrical wiring box is configured to receive the EVSE housing via one or more fasteners.

12. The system of claim 11, wherein the electrical wiring box comprises an electrical wiring box faceplate, wherein the electrical wiring box faceplate is removable to attach the EVSE housing.

13. The system of claim 11, wherein the electrical wiring box contains a utility wiring, wherein the utility wiring comprises one or more utility wires, and wherein the one or more utility wires are configured to connect to the one or more EVSE wires via one or more wire connectors to provide utility power from the utility wiring to the electronics.

14. The system of claim 10, further comprising:
a cable coupler disposed within the EVSE housing, wherein at least a portion of the cable coupler is encapsulated by the potting compound;
a cable connected to the cable coupler; and
a vehicle coupler connected to the cable, wherein the vehicle coupler is configured to connect to an electric vehicle.

15. A method, comprising:
removing an electrical wiring box faceplate from an electrical wiring box, wherein the electrical wiring box contains a utility wiring;
securing one or more wires of the utility wiring to one or more wires of an EVSE via one or more wire connectors, wherein the one or more wires of the EVSE are connected to electronics of the EVSE, and wherein a portion of the one or more wires of the EVSE and the electronics of the EVSE are encapsulated in a potting compound; and
securing a housing of the EVSE to the electrical wiring box via one or more fasteners.

16. The method of claim 15, further comprising:
detaching the housing of the EVSE from the electrical wiring box via the one or more fasteners;
detaching the one or more wires of the utility wiring from the one or more wires of the EVSE via the one or more wire connectors; and
attaching the electrical wiring box faceplate to the electrical wiring box, wherein the electrical wiring box contains the utility wiring.

17. The method of claim 15, wherein a cable coupler is disposed within the EVSE housing, and wherein at least a portion of the cable coupler is encapsulated by the potting compound.

18. The method of claim 17, wherein a cable is connected to the cable coupler.

19. The method of claim 18, wherein a vehicle coupler is connected to the cable.

20. The method of claim 19, wherein the vehicle coupler is configured to connect to an electric vehicle.
